(19) United States
(12) Patent Application Publication
(10) Pub. No.: US 2023/0096846 A1
(43) Pub. Date: Mar. 30, 2023

(54) CONTROLLING PLAYBACK OF AUDIO DATA

(71) Applicant: Elektrobit Automotive GmbH, Erlangen (DE)

(72) Inventor: Christof Rueß, Weissenhorn (DE)

(73) Assignee: Elektrobit Automotive GmbH, Erlangen (DE)

(21) Appl. No.: 17/949,714

(22) Filed: Sep. 21, 2022

(30) Foreign Application Priority Data
Sep. 24, 2021 (EP) 21198891.0

(51) Int. Cl. G10L 21/0208; G06F 3/16

(52) U.S. Cl. CPC G10L 21/0208; G06F 3/165

(57) ABSTRACT

Playback of audio data is controlled by: receiving a speech signal to be conveyed to a user simultaneously with playback of the audio data. Volume and/or spectral appearance of selected elements of the audio data are then modified to obtain adjusted audio data, and the adjusted audio data is played back. The received speech signal may then be played back simultaneously with the adjusted audio data.

### BACKGROUND

The present invention is related to a method, a computer program code, and an apparatus for controlling playback of audio data. The invention is further directed towards a motor vehicle and an electronic device making use of such a method or apparatus, as well as to a media format suitable for use with such a method or apparatus.

Today's vehicles are typically equipped with systems for playback of audio data, e.g. music or audiobooks. As such systems are often used to provide information about the vehicle, they are also referred to as infotainment systems.

In case a verbal announcement needs to be made during playback of audio data, e.g. a navigation command, but also in case of a phone call or a notification from a messenger or social media, audio playback needs to be controlled in such way that the driver of the vehicle is able to understand the announcement or the phone call. In currently available car infotainment systems, verbal announcements typically only lead to a reduction of the volume of the currently played media for at least some speakers.

In this regard, US 2017/0193991 A1 discloses an apparatus for enhancing speech prompts in a vehicle. The apparatus includes an audio processor that is electrically coupled to a plurality of loudspeakers in a vehicle. The audio processor is programmed to provide entertainment data to the plurality of loudspeakers for playback in the vehicle and to receive a speech prompt indicative of only a spoken audio output to a driver in the vehicle. The audio processor is further programmed to mute the entertainment data that is played back on a first loudspeaker of the plurality of loudspeakers in response to the speech prompt and to provide the speech prompt to the first loudspeaker for playback to the driver in response to the speech prompt.

Unfortunately, simply reducing the volume of the currently played media may lead to bad comprehensibility of the voice-over. In addition, it compromises the music or media listening experience.

With the ever-increasing processing power of electronic systems, infotainment systems are now capable of more sophisticated audio processing.

For example, US 2021/0204059 A1 discloses a method for generating audio via a loudspeaker system in a vehicle. Incoming audio signals from a vehicle microphone array are received and beamforming is applied to the incoming audio signals. It is then determined whether human generated sound is detected within the audio signal. In response to human generated sound being detected, a loudspeaker configured to emit non-human sound is instructed to adjust the non-human sound.

US 2018/0083587 A1 discloses a method for adjusting audio file playback in terms of volume and/or compression. An audio file is separated into tracks, each attributable to a different instrument. The instrument for which the audio signals are dominant or loudest are determined and settings for the volume preference of the audio signals attributable to each different instrument are accessed. The setting for the volume preference of the audio signals attributable to the instrument that is dominant or loudest are modified based on user input altering a volume at which the audio file is output without modification of the setting for the volume preference of the audio signals attributable to another instrument. Furthermore, the audio signals are amplified or attenuated based upon the modified setting.

It is an object of the present invention to provide an improved solution for controlling playback of audio data when a speech signal shall be conveyed to a user simultaneously with playback of the audio data.

### BRIEF SUMMARY

This object is achieved by a method according to claim 1, by a computer program code according to claim 11, which implements this method, and by an apparatus according to claim 12. This object is further achieved by a motor vehicle according to claim 13, by an electronic device according to claim 14, and by audio data as defined in claim 15. The dependent claims include advantageous further developments and improvements of the present principles as described below.

According to a first aspect, a method for controlling playback of audio data comprises the steps of:
receiving a speech signal to be conveyed to a user simultaneously with playback of the audio data;
modifying volume and/or spectral appearance of selected elements of the audio data to obtain adjusted audio data; and
playing back the adjusted audio data.

Accordingly, a computer program code comprises instructions, which, when executed by at least one processor, cause the at least one processor to perform the following steps for controlling playback of audio data:
receiving a speech signal to be conveyed to a user simultaneously with playback of the audio data;
modifying volume and/or spectral appearance of selected elements of the audio data to obtain adjusted audio data; and
playing back the adjusted audio data.

The term computer has to be understood broadly. In particular, it also includes mobile devices, embedded devices and other processor-based data processing devices.

The computer program code can, for example, be made available for electronic retrieval or stored on a computer-readable storage medium.

According to another aspect, an apparatus for controlling playback of audio data comprises:
a receiving unit configured to receive a speech signal to be conveyed to a user simultaneously with playback of the audio data;
a modifying unit configured to modify volume and/or spectral appearance of selected elements of the audio data to obtain adjusted audio data; and
a playback unit configured to play back the adjusted audio data.

Accordingly, audio data that is particularly suitable for use with a solution according to the invention includes meta information about a content structure of the audio data.

To solve the problems outlined above, according to the invention, the volume of the currently played audio data is not simply reduced. Instead, the volume or spectral appearance of selected elements of the audio data is adjusted such that the comprehensibility of the additional speech signal is improved. With advanced audio processing capabilities, such as classic filters and content aware separators or filters, and new stem- or object-based audio formats, audio content can easily be modified or adapted to better fit to different listening scenarios. By separating wanted and unwanted elements, their volume and spectral appearance can be adjusted individually. In scenarios with multiple speakers, the processing can be applied selectively to those speakers that are directed to at least one target person.

Stem- and object-based audio formats are becoming increasingly available. Where not available, content aware filters or machine learning based approaches, such as Spleeter (https://github.com/deezer/spleeter), are able to provide convincing results of stem extraction from mixdowns. When high processing power is not available or low-latency processing is needed, classic algorithms provide adequate quality.

Depending on the source of the audio data, different types of preprocessing may be applied for separating wanted and unwanted elements. For live audio, such as radio, approaches using classic filters and, to a certain extent, content aware separators or filters may be used. For offline media or offline streamed media, classic filters and content aware filters may be used. For stem-based media and object-based media, no preprocessing is needed, as the elements are defined by the stems or objects.

In an advantageous embodiment, the received speech signal is played back simultaneously with the adjusted audio data. In case the received speech signal is to be conveyed to the user by an audio system that is also used for playback of the audio data, the speech signal is played back by this system together with the adjusted audio data. In this way, the adjusted audio data and the speech signal are optimally synchronized.

In an advantageous embodiment, playing back the received speech signal is delayed based on meta information associated with the audio data and/or based on external data. With additional meta information, which may be provided together with the audio data, through an external source or through content analysis and detection, playback of the speech signal can be deliberately delayed for better integration in the flow of the audio data. For example, playback may begin in interludes or before chorus. This leads to an improved listening experience. Delaying playback may be dependent on different metrics, such as a priority. The placement of the speech signal may also be influenced by external data, e.g., to reduce the influx of information in order to maintain a driver's focus. Metrics for this can be driving situations, which may be derived by evaluating map data, traffic data, or sensor data, or information on stress or attention of the user.

In an advantageous embodiment, the speech signal to be conveyed is an announcement, a notification, verbal information of a voice call, or verbal information uttered by another user. A main field of application of the described solution is playback of announcements, such as navigation commands, or notifications from messengers or social media. In this application, the duration of the speech signal is known and the beginning of playback can be easily controlled. However, the described solution is likewise useful for voice calls that take place during playback of audio data. Another application is to ease discussions between persons in audio zones. For this purpose, microphones that are already present for voice interaction may be used.

In an advantageous embodiment, the selected elements of the audio data are adjusted by attenuating or removing vocal content of the audio data. Vocal content typically is the most salient element. Therefore, by attenuating or completely removing vocals, the comprehensibility of overlaid voice messages can be significantly improved. At the same time, the background music may remain at full volume.

In an advantageous embodiment, the selected elements of the audio data are further adjusted by filtering background music. Instead of keeping background music at full volume, it may likewise be filtered in order to further improve the acoustic intelligibility of a voice-over. In particular, filters can be applied to reduce spectral components that are potentially impeding comprehensibility.

In an advantageous embodiment, the selected elements of the audio data are further adjusted by looping a segment of the audio data. In compositions containing segments that may be repeated in a loop, the playback can be trapped in such a loop at an adequate location while the additional speech signal is played back. This corresponds to a virtual pausing of the audio data. In order to determine segments that are suitable for a loop, meta information about the content structure of the audio data may be used.

In an advantageous embodiment, playback speed of the speech signal is adapted to a duration of the looped segment. Based on information about the length of the segment that is repeated in a loop, the playback speed of the speech signal can be adjusted for better temporal matching. In this way, playback of the original audio data can be resumed immediately following the end of the speech signal.

In an advantageous embodiment, duration of the adjusted audio data is dependent on a duration of the received speech signal. In addition to the modification of the acoustic appearance, also the duration of the intervention can be influenced depending on the overlaid content. For example, the duration of the adjusted audio data may be identical to the duration of the received speech signal. Alternatively, it may be a little bit longer than the duration of the received speech signal. This allows avoiding an abrupt change from the audio data to the overlaid speech signal, and vice versa.

In an advantageous embodiment, the duration of the adjusted audio data allows for a feedback by the user following the speech signal. For announcements that require a response by the user, the duration of the adjusted audio data can be extended to signal the expectation of an answer and to improve the dialog, e.g. by improving voice recognition. This also omits the need for signal sounds for an “end of voice command” and may also have a positive impact on the user's attention as well as on voice command processing.

Advantageously, a motor vehicle or an electronic device capable of playback of audio data comprises an apparatus according to the invention or is configured to perform a method according to the invention for controlling playback of audio data. Use of the invention is particularly useful for announcements, voice calls or user conversations. For example, the motor vehicle may be a car. The electronic device may, for example, be a smartphone, a tablet, a smart speaker or a television set.

Further features of the present invention will become apparent from the following description and the appended claims in conjunction with the figures.

### BRIEF DESCRIPTION OF THE DRAWINGS

FIG. 1 schematically illustrates a method for controlling playback of audio data;

FIG. 2 schematically illustrates a first embodiment of an apparatus for controlling playback of audio data;

FIG. 3 schematically illustrates a second embodiment of an apparatus for controlling playback of audio data;

FIG. 4 schematically illustrates a motor vehicle in which a solution according to the invention is implemented;

FIG. 5 schematically illustrates an electronic device in which a solution according to the invention is implemented; and

FIG. 6 shows a system diagram of a solution according to the invention.

### DETAILED DESCRIPTION

The present description illustrates the principles of the present disclosure. It will thus be appreciated that those skilled in the art will be able to devise various arrangements that, although not explicitly described or shown herein, embody the principles of the disclosure.

All examples and conditional language recited herein are intended for educational purposes to aid the reader in understanding the principles of the disclosure and the concepts contributed by the inventor to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the diagrams presented herein represent conceptual views of illustrative circuitry embodying the principles of the disclosure.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, systems on a chip, microcontrollers, read only memory (ROM) for storing software, random access memory (RAM), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a combination of circuit elements that performs that function or software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

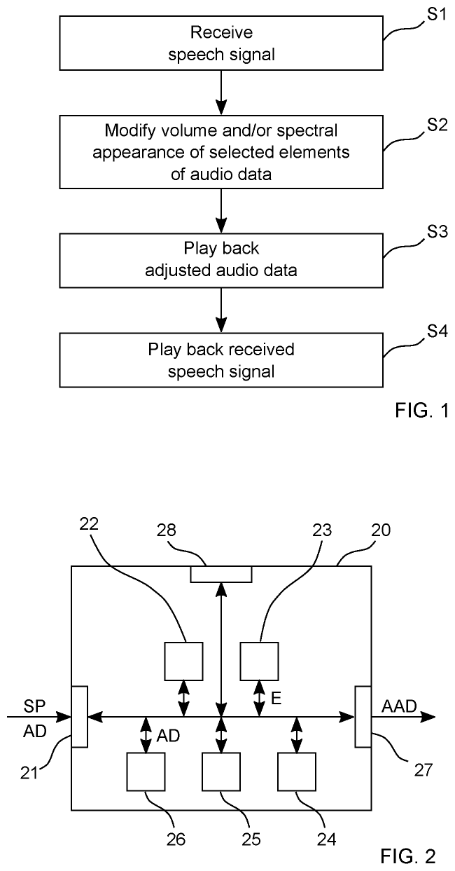

FIG. 1 schematically illustrates a method according to the invention for controlling playback of audio data. In a first step, a speech signal to be conveyed to a user simultaneously with playback of the audio data is received S1, such as an announcement, a notification, verbal information of a voice call, or verbal information uttered by another user. Volume and/or spectral appearance of selected elements of the audio data are then modified S2 to obtain adjusted audio data. For example, vocal content of the audio data may be attenuated or removed. In addition, background music may be filtered and/or a segment of the audio data may be repeated in a loop. Advantageously, a duration of the adjusted audio data is dependent on a duration of the received speech signal. The duration may allow for a feedback by the user following the speech signal. The adjusted audio data is then played back S3. The received speech signal may then be played back S4 simultaneously with the adjusted audio data. However, playing back S4 the received speech signal may be delayed based on meta information associated with the audio data and/or or based on external data. In addition, in case that a segment of the audio data is repeated in a loop, a playback speed of the speech signal may be adapted to a duration of the looped segment.

FIG. 2 schematically illustrates a block diagram of a first embodiment of an apparatus 20 according to the invention for controlling playback of audio data AD. The apparatus 20 has an input 21, via which a receiving unit 22 receives a speech signal SP to be conveyed to a user simultaneously with playback of the audio data AD, such as an announcement, a notification, verbal information of a voice call, or verbal information uttered by another user. The audio data AD may likewise be received via the input 21 or retrieved from a local storage unit 26. A modifying unit 23 is configured to modify volume and/or spectral appearance of selected elements E of the audio data AD to obtain adjusted audio data AAD. For example, vocal content of the audio data AD may be attenuated or removed. In addition, background music may be filtered and/or a segment of the audio data AD may be repeated in a loop. Advantageously, a duration of the adjusted audio data AAD is dependent on a duration of the received speech signal SP. The duration may allow for a feedback by the user following the speech signal SP. A playback unit 24 is configured to play back the adjusted audio data AAD. For this purpose, the adjusted audio data AAD may be made available via an output 27. However, playing back the received speech signal SP may be delayed based on meta information associated with the audio data AD and/or or based on external data. In addition, in case that a segment of the audio data AD is repeated in a loop, a playback speed of the speech signal SP may be adapted to a duration of the looped segment. The output 27 may be combined with the input 21 into a single interface. The local storage unit 26 may further be used for storing data during processing.

The receiving unit 22, the modifying unit 23, and the playback unit 24 may be controlled by a control module 25. A user interface 28 may be provided for enabling a user to modify settings of the receiving unit 22, the modifying unit 23, the playback unit 24, and the control module 25. The receiving unit 22, the modifying unit 23, the playback unit 24, and the control module 25 can be embodied as dedicated hardware units. Of course, they may likewise be fully or partially combined into a single unit or implemented as software running on a processor, e.g. a CPU or a GPU.

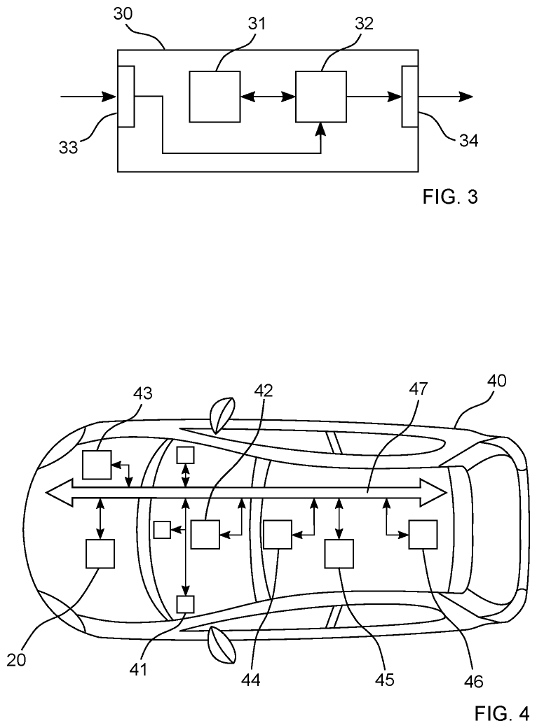

A block diagram of a second embodiment of an apparatus 30 according to the invention for controlling playback of audio data is illustrated in FIG. 3. The apparatus 30 comprises a processing device 32 and a memory device 31. For example, the apparatus 30 may be a computer, an electronic control unit or an embedded system. The memory device 31 has stored instructions that, when executed by the processing device 32, cause the apparatus 30 to perform steps according to one of the described methods. The instructions stored in the memory device 31 thus tangibly embody a program of instructions executable by the processing device 32 to perform program steps as described herein according to the present principles. The apparatus 30 has an input 33 for receiving data. Data generated by the processing device 32 are made available via an output 34. In addition, such data may be stored in the memory device 31. The input 33 and the output 34 may be combined into a single bidirectional interface.

The processing device 32 as used herein may include one or more processing units, such as microprocessors, digital signal processors, or a combination thereof.

The local storage unit 26 and the memory device 31 may include volatile and/or non-volatile memory regions and storage devices such as hard disk drives, optical drives, and/or solid-state memories.

FIG. 4 schematically shows a motor vehicle 40, in which a solution in accordance with the invention is implemented. In this example, the motor vehicle 40 is a car. The car has a number of speakers 41 for providing audio playback to passengers of the motor vehicle 40. Audio signals may be provided to the speakers 41 by an infotainment system 42. Further components of the motor vehicle 40 in this example are a navigation system 43 and environment sensors 44, such as ultrasonic sensors, laser scanners, lidar sensors, radar sensors, or cameras. The navigation system 43 may generate announcements, which may need to be played back in parallel to audio playback. Likewise, data derived by the environment sensors 44 may lead to the generation of warning announcements, which may need to be played back in parallel to audio playback. Therefore, the motor vehicle 40 comprises an apparatus 20 according to the invention for controlling playback of audio data. In this example, the apparatus 20 is a self-contained unit. Of course, the apparatus 20 may likewise be incorporated into the infotainment system 42, for example. By means of a data transmission unit 45 a connection to a backend can be established, e.g. to receive audio data for playback or updated program code. Audio data for playback may also be received via local audio interfaces, such as Bluetooth, memory interfaces, auxiliary inputs, etc. A memory 46 is available for storing data. The data exchange between the different components of the motor vehicle 40 takes place via a network 47.

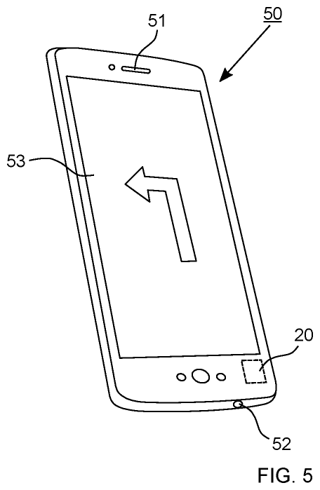

FIG. 5 schematically illustrates an electronic device 50 in which a solution in accordance with the invention is implemented. In this example, the electronic device 50 is a smartphone. The smartphone has a speaker 51, via which audio playback is possible. Audio playback may likewise be performed via a headset (not shown) connected to a socket 52 of the smartphone. A navigation application running on the smartphone may provide visual navigation instructions to a user of the smartphone via a screen 53. The navigation application may further generate announcements, which may need to be played back in parallel to audio playback. Likewise, other applications, such as messengers or social media applications, may generate notifications that need to be played back. Therefore, the smartphone comprises an apparatus 20 according to the invention for controlling playback of audio data.

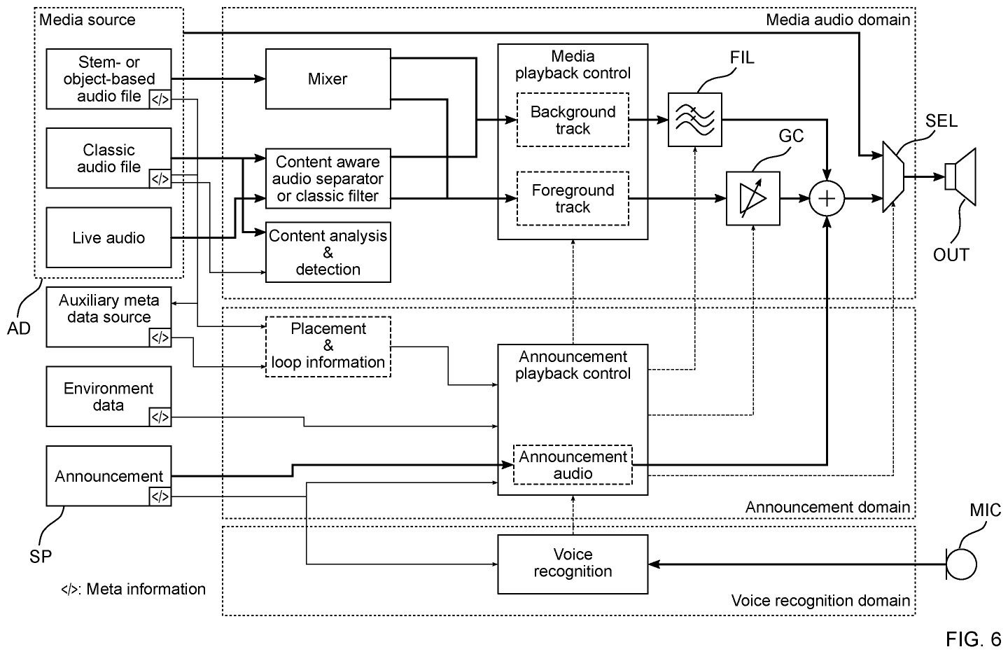

FIG. 6 shows a system diagram of a solution according to the invention. In this example, the speech signal to be conveyed to a user is an announcement. In the figure, the thick lines indicate the flow of audio data, the solid thin lines indicate the flow of meta information, and the dashed lines indicate the flow of control information. The system diagram is split into three different domains, i.e., a media audio domain, an announcement domain, and a voice recognition domain. Audio data may originate from different media sources. Absent any announcement, the audio data are simply provided to a selector SEL and output to one or more audio outputs OUT, which are symbolized by a speaker. The selector SEL is optional and symbolizes that the advanced audio processing is only needed when a speech signal shall be integrated.

In case of an announcement, however, the audio data from the different media sources is processed in the media audio domain. For example, a stem-based or object-based audio file may be provided to a mixer, which outputs a background track and a foreground track, e.g. vocal content, to a media playback control block. Alternatively, a classic audio file or live audio may be provided to a content aware audio separator or a classic filter for processing. This audio separator or filter then outputs a background track and a foreground track to the media playback control block. The media playback control block provides the background track to a filter FIL, e.g. for reducing spectral components that are potentially impeding comprehensibility. The foreground track is provided to a gain control GC for attenuation or removal.

Meta information, which may be associated with the audio data, obtained from an auxiliary meta data source, or derived by a content analysis and detection block, is provided to an optional placement and loop information block, which determines an appropriate placement of announcement as well as a segment of the audio data that may be repeated in a loop, if such a segment should be available. The placement and loop information block provides the respective information to an announcement playback control block. The announcement playback control block initiates operation of the media playback control block, the filter FIL, and the gain control GC with the appropriate timing, and provides the audio signal of the announcement to a combiner. The placement of the announcement may also be influenced by external data. Metrics for this can be driving situations, which may be derived by evaluating map data, traffic data, or sensor data, or information on stress or attention of the user. The combiner combines this audio signal with the adjusted foreground track and the adjusted background track, and provides the combined audio signal to the selector SEL. The selector SEL is controlled by the announcement playback control block in such way that the combined audio signal is output to the speaker SPK.

In the voice recognition domain, voice data acquired by one or more microphones MIC are evaluated by a voice recognition block. Voice recognition may be triggered by the announcement. The voice recognition preferably provides a signal to the announcement playback control block that voice recognition is completed. In this way, the announcement playback control block can terminate adjustment of the foreground track and the background track and switch back to unaltered audio playback by providing an appropriate signal to the selector SEL.

### REFERENCE NUMERALS

20 Apparatus
21 Input
22 Receiving unit
23 Modifying unit
24 Playback unit
25 Control module
26 Local storage unit
27 Output
28 User interface
30 Apparatus
31 Memory device
32 Processing device
33 Input
34 Output
40 Motor vehicle
41 Speaker
42 Infotainment system
43 Navigation system
44 Environment sensors
45 Data transmission unit
46 Memory
47 Network
50 Electronic device
51 Speaker
52 Socket
53 Screen
AAD Adjusted audio data
AD Audio data
E Element
FILFilter
GC Gain control
MIC Microphone
OUT Audio output
SEL Selector
SP Speech signal
S1 Receive speech signal
S2 Modify volume and/or spectral appearance of selected elements of audio data
S3 Play back adjusted audio data
S4 Play back received speech signal

1. A method for controlling playback of audio data, the method comprising:
receiving a speech signal to be conveyed to a user simultaneously with playback of the audio data;
modifying volume and/or spectral appearance of selected elements of the audio data to obtain adjusted audio data; and
playing back the adjusted audio data;
wherein the selected elements of the audio data are modified by attenuating or removing vocal content in a foreground track of the audio data independently from processing of a background track of the audio data.

2. The method according to claim 1, further comprising playing back the received speech signal simultaneously with the adjusted audio data.

3. The method according to claim 2, wherein playing back the received speech signal is delayed based on meta information associated with the audio data and/or or based on external data.

4. The method according to claim 3, wherein the speech signal (SP) to be conveyed is an announcement, a notification, verbal information of a voice call, or verbal information uttered by another user.

5. The method according to claim 4, wherein the selected elements of the audio data are further adjusted by filtering background music.

6. The method according to claim 5, wherein the selected elements of the audio data are further adjusted by looping a segment of the audio data.

7. The method according to claim 6, wherein a playback speed of the speech signal is adapted to a duration of the looped segment.

8. The method according to claim 7, wherein a duration of the adjusted audio data is dependent on a duration of the received speech signal.

9. The method according to claim 8, wherein the duration of the adjusted audio data allows for a feedback by the user following the speech signal.

10. A motor vehicle having an apparatus for controlling playback of audio data, the apparatus comprising:
a receiving unit configured to receive a speech signal to be conveyed to a user simultaneously with playback of the audio data;
a modifying unit configured to modify volume and/or spectral appearance of selected elements of the audio data to obtain adjusted audio data; and
a playback unit configured to play back the adjusted audio data;
wherein the selected elements of the audio data are modified by attenuating or removing vocal content in a foreground track of the audio data independently from processing of a background track of the audio data.

11. The motor vehicle of claim 10, wherein the apparatus for controlling playback of audio data, is further configured for: playing back the received speech signal simultaneously with the adjusted audio data.

12. The motor vehicle of claim 11, wherein playing back the received speech signal is delayed based on meta information associated with the audio data and/or or based on external data.

13. The motor vehicle of claim 12, wherein the speech signal (SP) to be conveyed is an announcement, a notification, verbal information of a voice call, or verbal information uttered by another user.

14. The motor vehicle of claim 13, wherein the selected elements of the audio data are further adjusted by filtering background music.

15. The motor vehicle of claim 14, wherein the selected elements of the audio data are further adjusted by looping a segment of the audio data.

16. The motor vehicle of claim 15, wherein a playback speed of the speech signal is adapted to a duration of the looped segment.

17. The motor vehicle of claim 16, wherein a duration of the adjusted audio data is dependent on a duration of the received speech signal.

18. The motor vehicle of claim 17, wherein the duration of the adjusted audio data allows for a feedback by the user following the speech signal.
